(19) United States
(12) Patent Application Publication
(10) Pub. No.: US 2007/0264703 A1
(43) Pub. Date: Nov. 15, 2007

(54) Microorganism and Method for Leaching Mineral Sulphides

(75) Inventors: Jason Joel Plumb, Western Australia (AU); Peter Damian Franzmann, Western Australia (AU)

Correspondence Address: MCDERMOTT WILL & EMERY LLP, 600 13TH STREET, N.W., WASHINGTON, DC, 20005-3096, US

(73) Assignee: COMMONWEALTH SCIENTIFIC AND INDUSTRIAL RESEARCH ORGANISATION, Campbell, Australian Capital Territory (AU)

(21) Appl. No.: 10/547,753

(22) PCT Filed: Mar. 4, 2004
(86) PCT No.: PCT/AU04/00279

§ 371 Date: Mar. 16, 2007

(30) Foreign Application Priority Data
Mar. 5, 2003 (AU) 2003901050

(51) Int. Cl. C02F 3/34

(52) U.S. Cl. 435/262

(57) ABSTRACT

The present invention relates to a method of bioleaching mineral sulphides at high temperatures and extremely low pH. In particular, the invention relates to a method which employs a microorganism of the genus Acidianus which is a thermophile and an extreme acidophile.

### FIELD OF THE INVENTION

The present invention relates to a method for bioleaching mineral sulphides.

The present invention relates particularly, although by no means exclusively, to bioleaching mineral sulphides at high temperatures and extremely low pH.

The present invention also relates to a microorganism that is capable of bioleaching mineral sulphides at high temperatures and extremely low pH.

### BACKGROUND OF THE INVENTION

All references, including any patents or patent applications, cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents forms part of the common general knowledge in the art in Australia or in any other country.

Microbial oxidation of refractory ores has proven to be a relatively simple and cost effective means of recovering metal from these materials. The microbial production of ferric ions by the oxidation of ferrous ions in the presence of air and acid creates conditions suitable, for instance, for the oxidation of otherwise refractory copper-bearing sulphides, allowing the release of copper from the ore in a soluble and recoverable form. Bioleaching of mineral sulphide ores offers, among other benefits, economic advantage over concentration and smelting and the ability to process mineral ores at a mine site. The bioleaching of low-grade mineral sulphide ores is now a commercial reality, and efforts to optimise this process will add to the value of industrial bioleaching applications.

The mechanisms by which bioleaching microorganisms oxidise mineral sulphides have been the subject of much previous research. It is suggested that the mechanisms involved are based on the ability of the microorganisms to oxidise Fe2+, sulphur compounds, or both, to produce Fe3+ and sulphuric acid, respectively. These two products act as leaching agents resulting in the chemical dissolution of mineral sulphide ores, as represented in the following equations:
CuFeS₂+2Fe₂(SO₄)₃→CuSO₄+5FeSO₄+2S⁰
4CuFeS₂+17O₂+2H₂SO₄→4CuSO₄+2Fe₂(SO₄)₃+2H₂O

The elemental sulphur and Fe²⁺ produced by the dissolution of the mineral sulphide can again be biologically oxidised to produce more leaching agents. Temperature and pH optima for the continued biological production of the leaching agents depend on the characteristics of the microorganisms involved. Mineral sulphide ores that contain iron, such as chalcopyrite, have proven to be difficult to bioleach, especially at mesophilic temperatures. The incomplete bioleaching of such ores has been attributed to an inhibiting layer that forms on the surface of the ore as it oxidises. It is thought that the inhibiting layer may contain elemental sulfur, which prevents access of bacteria and chemical oxidants from the surface. Another theory implicates the formation of ferric-hydroxy precipitates such as jarosites, which deposit on the surface of mineral sulphides, preventing their oxidation. Jarosite formation is minimised at extremely low pH (<1.0) or at low redox potentials.

It is known that improved bioleaching of mineral sulphide ores, such as chalcopyrite, occurs with increasing temperatures. Thermophilic organisms, which grow at temperatures higher than 60° C., achieve much greater rates of mineral dissolution when compared with moderate thermophiles, which grow in the range of 40-60° C., and mesophiles, which grow in the temperature range of 10-40° C.

Other studies have demonstrated the ability of thermophilic acidophiles to oxidise ferrous iron and sulphur and leach mineral sulphide concentrates at high temperatures. The lower pH limit for growth of these organisms is approximately 1.0. Leaching using these and other similar organisms is not able to benefit from the advantages associated with leaching at pH 1.0 or lower. These organisms are unable to grow at the low pH at which ferric iron solubility is greatest and at which mineral leaching is not retarded. In addition, oxidation of mineral sulphides that results in a nett production of acid (e.g. pyritic ores) can cause a considerable decrease in pH in the bioleaching environment and potentially inhibit the growth of conventional bioleaching microorganisms.

Accordingly, there is a need for the development of a bioleaching process that takes advantage of the faster leaching rates obtained at high temperatures and avoids the problems associated with the retardation of bioleaching that takes place due to decreases in ferric iron solubility as pH increases.

### SUMMARY OF THE INVENTION

The inventors have now developed a method of bioleaching mineral sulphides that alleviates one or more of the problems described above. This method utilises microorganisms that are capable of leaching mineral sulphide ores at high temperatures and at extremely low pH (pH less than 1.0).

In a first aspect, the present invention provides a method of recovering a valuable metal from a mineral sulphide, which includes the steps of:

(i) bioleaching the mineral sulphide at a pH of less than 1.0 and at a temperature of at least 50° C. with a microorganism capable of contributing to bioleaching the mineral sulphide under these conditions to produce a bioleachate solution containing dissolved metal; and

(ii) recovering the metal from the solution.

It will be appreciated by the person skilled in the art that any microorganism that is capable of contributing to bioleaching mineral sulphide material at a temperature of at least 50° C. and a pH of less than 1.0 can be used.

Persons skilled in the art will also appreciate that the method disclosed herein may be used on a wide variety of mineral sulphides such as arsenopyrite, bornite, chalcocite, cobaltite, enargite, galena, greenockite, millerite, molybdenite, orpiment, pentlandite, pyrite, pyrrhotite, sphalerite, stibnite, chalcopyrite or mixtures of these, that might contain at least one of the following metal values: copper, silver, gold, zinc, cobalt, germanium, lead, arsenic, antimony, tungsten, nickel, palladium, platinum, or uranium. Preferably, the mineral sulphide material is one which contains iron, such as arsenopyrite, bornite, chalcopyrite, pyrite or pyrrhotite, or where iron is present in the ore matrix.

More preferably, the mineral sulphide material is a chalcopyrite-bearing ore or a pyritic ore which is able to produce acid upon oxidation.

Preferably the mineral sulphide material contains iron and the microorganism is capable of contributing to bioleaching by oxidising either or both of ferrous iron and sulphur compounds, and more preferably both iron and sulphur under the conditions described above and produce ferric ions and acidic conditions, both of which contribute to improving the rate of leaching of the metal from the mineral sulphide material.

Preferably, the microorganism is capable of contributing to bioleaching mineral sulphide material by oxidising mineral sulphide material at temperatures of 50° C. or greater, and preferably from 50° C. to 850° C., in order to maximise the rate of dissolution of the material. It will be appreciated that greater rates of mineral dissolution will be obtainable at higher temperatures, at the trade-off of the cost to heat and maintain the mineral sulphide at such a temperature. Experimentation to determine the optimal temperature range for the rate of mineral dissolution and cost would be a matter of routine. In particular embodiments the microorganism is capable of contributing to bioleaching mineral sulphide material by oxidising mineral sulphide material at temperatures of at least 55° C., at least 60° C., at least 65° C., at least 70° C. at least 80° C. or at least 85° C.

Preferably, the microorganism is a thermophile. A moderate thermophile may also provide suitable bioleaching activity towards the lower end of the preferred temperature range.

In a particular embodiment, the microorganism is an acidophile capable of contributing to bioleaching mineral sulphide material at a pH of less than 1.0 so as to minimise retardation of the oxidation of the mineral sulphide, for instance by minimising jarosite formation or the formation of an inhibiting layer of elemental sulfur on the surface of the mineral sulphide. In further embodiments the organism is able to contribute to bioleaching at a pH of from 0.9 or less, from 0.8 or less, from 0.7 or less, from 0.6 or less, from 0.5 or less, from 0.4 or less or from 0.3 or less. Microorganisms capable of contributing to bioleaching at a pH from less than 1.0 up to pH 2.0 are also contemplated.

In one embodiment, the microorganism is of the domain Archaea, and preferably the organism is strain JP7 [Acidianus sp. JP7, Accession Number DSM 15471, deposited with the Deutsche Sammlung von Mikroorganismen und Zellkulturen GmbH (DSMZ) 24 Feb. 2003]

A person of skill in the art would recognise that the bioleaching process may be carried out using a variety of techniques that are known in the art. These techniques may include a heap process, a dump leaching process, a reactor leaching system or an in situ leaching process, provided that the process can deliver the appropriate temperature, pH, oxygen and nutrient requirements for bioleaching by the microorganism.

Preferably, a heap configuration is used in view of the lower operating costs involved in heap biooxidation. In examples where high metal values such as gold are targeted, a reactor configuration for bioleaching may be economically favourable.

In a second aspect, the invention provides an isolated microorganism suitable for use in bioleaching mineral sulphide material at a pH of less than 1.0 and at a temperature of at least 50° C.

Preferably the microorganism is able to oxidise both ferrous ions and sulphur from mineral sulphide material under the conditions described above. Microorganisms able to tolerate and/or grow at temperatures between 50° C. to 85° C. offer the advantage of maximising the rate of dissolution of the mineral material.

Accordingly, preferably, the microorganism is a thermophile, although a moderate thermophile may also provide suitable bioleaching activity towards the lower end of the preferred temperature range.

Preferably the microorganism is an acidophile capable of contributing to bioleaching mineral sulphide material at a pH from 0.3 to 1.0, so as to minimise the formation of ferric ion precipitates on the mineral sulphide material particles which may inhibit bioleaching. More preferably, the microorganism is capable of contributing to bioleaching mineral sulphide material at a pH of 0.8.

In one embodiment, the microorganism is of the domain Archaea, and preferably the organism is JP7 [Acidianus sp. JP7 Accession Number DSM 15471, deposited with the Deutsche Sammlung von Mikroorganismen und Zellkulturen GmbH (DSMZ) 24 Feb. 2003].

In another aspect, the invention provides the use of Acidianus sp. JP7 (Accession Number DSM 15471) for bioleaching a mineral sulphide.

In yet another aspect, an isolated culture of Acidianus sp. JP7 (Accession Number DSM 15471) is provided.

### BRIEF DESCRIPTION OF THE FIGURES

FIG. 1 shows the phylogenetic tree based on 16S rDNA sequence data that illustrates the relatedness of JP7 to described members of the genera Acidianus and Sulfolobus and other JP isolates. Scale=10% divergence. JP7 was capable of growing at temperatures of 50° C. to 80° C. and over a pH range of 0.3 to at least 2.2.

FIG. 2 is table summarizing key characteristics of strain JP7 and previously described species of the genus Acidianus

FIG. 3 is a series of growth curves for shake flask cultures of strain JP7 growing at 70° C. on 1% w/v chalcopyrite concentrate at different pH. Cell counts were obtained using a Thoma counting chamber.

FIG. 4 is a plot showing the % of Cu release from a chalcopyrite concentrate over time at 70° C., at pH 0.8 (using JP 7) and pH 1.8 (using Sulfolobus sp. strain JP 2). Uninoculated controls (“cont”) at each pH are also shown.

FIG. 5 illustrates measurements of iron in solution over time for chalcopyrite concentrate leaching at 70° C. by JP7 (at pH 0.8) and JP2 (at pH 1.8), and also for uninoculated controls (“cont”).

FIG. 6 is a photomicrograph showing samples from chalcopyrite leaching tests with JP2 at pH 1.8. Particles of chalcopyrite (C) and ferric precipitates (F) can be seen. The small irregular JP2 cocci are also evident in this photograph.

FIG. 7 is a photomicrograph showing samples from chalcopyrite leaching tests with JP7 at pH 0.8. Particles of chalcopyrite (C) can be seen. The small irregular coccus-like cells of JP7 are also evident in this photograph. The typically yellow ferric precipitates seen in FIG. 6 were not present in FIG. 7.

FIG. 8 is the near complete sequence of the 16S ribosomal RNA derived from the 16S rDNA sequence of JP7.

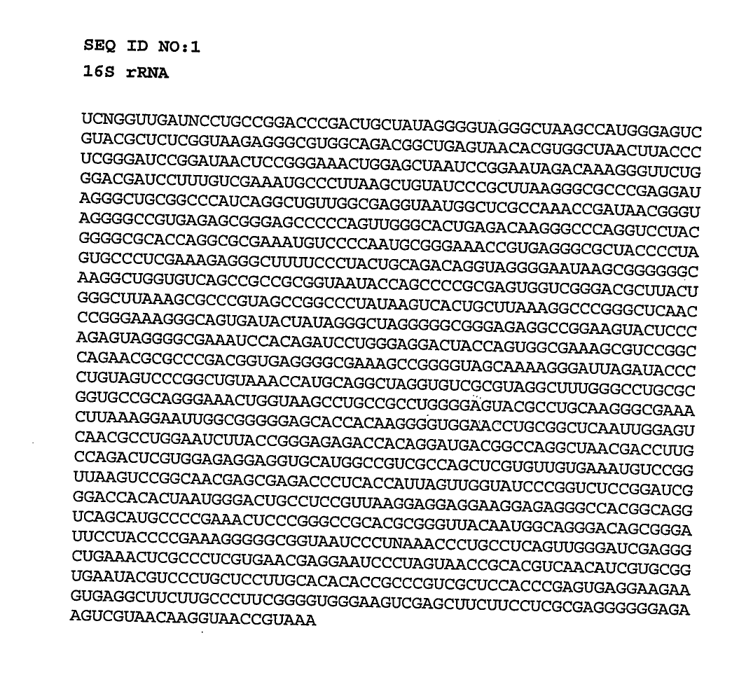

### DETAILED DESCRIPTION OF THE PREFERRED EMBODIMENT

Bioleaching Processes May be Carried Out Using a Variety of Methods.

Closed tank biooxidation processes may be used especially for mineral sulphide ores that have relatively high precious metal value concentrations, or alternatively, can be used for the biooxidation of a concentrate produced from a low grade ore. This technology has been demonstrated previously and is described in U.S. Pat. No. 6,096,113.

Tank or reactor leaching involves the bioleaching of an ore or concentrate in a closed vessel or series of closed vessels where physical and chemical conditions are maintained at near-optimal conditions for the growth and metabolism of the bioleaching agents. Such vessels are generally loaded with finely crushed ore of particle size of approximately 50 μm or similar and inoculated with a pure or mixed culture of the desired bioleaching organisms. Parameters such as pH, temperature, nutrients, the type and concentration of sulphur-containing compounds and solution redox potential may be controlled at optimal levels for growth, and aeration may be achieved through mechanical agitation or gasification with air or carbon dioxide-amended air. Non-precious metals such as copper may be recovered from solution by solvent extraction and electrowinning. Precious metals such as gold may be recovered from ore residues through the use of a lixiviant such as cyamide or similar.

Heap biooxidation or open air, heap bioleaching, where target metal is leached out of a bed of crushed ore by circulating or percolating leaching solution, is an attractive alternative for bioleaching because of the simplicity of implementation and low capital and operating costs. Accordingly, heap biooxidation processes are particularly applicable to low grade and waste type ores (Brierley, C. L. Biooxidation-heap technology for pre-treatment of refractory sulphidic gold ore. Biomine 1994 (Perth, Wash.), Australian Mineral Foundation, Glenside, SA, 10.1-10.8; Montealegre, R., Bustos, S, and Rauld, J. (1995), Copper sulfide hydrometallurgy and the thin layer bacterial-technology of Sociedad Minera Pudahuel. Copper 1995 (Santiago, Chile), Volume III, edited by W. C. Cooper, D. B. Dreisinger, J. E. Dutrizac, H. Hein and G. Ugarte, TMS, Warrendale, Pa., 781-793.).

Heap leaching of mineral sulphide ores may proceed using methods described previously by Readett (Straits resources limited and the industrial practice of copper bioleaching in heaps. Australasian Biotechnology, 2001, 11, 30-31.), and U.S. Pat. No. 6,383,458, whereby said ore is crushed and blended if necessary before being agglomerated to a particle size of approximately 25 mm. Agglomerated ore is then stacked using a conveyer onto a leach pad into a heap arrangement. A typical heap may have dimensions of 500 m×100 m×9 m and is constructed with an internal network of pipes to provide aeration and reticulated on the top of the heap with an irrigation system consisting of sprinklers, drippers or wobblers. An acidic leach solution containing ferrous ion and sulphurous compounds is irrigated onto the heap. Microorganisms for bioleaching may be innoculated onto the heap via the irrigation system. The heap may be operated at above ambient temperatures and as high as 85° C. As the leach solution percolates through the heap matrix, metal such as copper, leached from the ore due to the action of the bioleaching microorganism/s is collected in solution form to produce a metal-rich pregnant leach solution.

Extraction and winning of the metal is typically but not exclusively performed by passage through a solvent extraction circuit where the metal is extracted from the aqueous solution by a metal-selective organic extractant before being returned to an aqueous solution. The resulting purified metal-rich aqueous solution is then subjected to electrowinning whereby the copper in solution is plated onto stainless steel cathodes.

The person skilled in the art will recognise that a heap may be produced using any of the techniques known in the art and that the dimensions of the heap can vary in size and shape depending on the ore and the limitations of the site.

The size of the sulfide ore particles will depend on the type of ore and the process used, although it will be appreciated that a smaller particle size will result in a greater surface area of the sulfide particles in the ore which will mean faster biooxidation of the sulphide particles. Ore crushing and desired particle size can be achieved by means well known in the art.

A microbial nutrient solution may be applied to the heap or bioreactor in order to maximise the growth and desired metabolic activity of the microorganism. The oxidation rate of the sulphides can be monitored to determine the need for nutrient additions or other supplements.

It may be advantageous to be able to control the temperature, pH, flow rate of leachate solution and the availability of oxygen during the bioleaching step in order to maintain optimal conditions for the maximisation of leaching rate and the efficiency of extraction of the valuable metal from the ore.

The bioleachate solution resulting from the bioleaching step can be collected and the metal recovered in a range of forms, depending on the process for recovery used. In the case of the bioleaching of copper from chalcopyrite or chalcocite, the copper may be recovered as metallic copper, through a subsequent solvent extraction and electrowinning process.

The invention will be described by way of reference only to the following non-limiting examples.

Materials and Methods

Source Sample Material

Samples were collected from terrestrial sites that were either volcanically or geothermally active and consisted of hot springs rich in sulphur and iron that had low pH. One of the sampling sites was where an open pit gold mine has been established in the crater of a dormant volcano.

Enrichment and Isolation

Selected samples collected from previously identified sites were pooled and used to inoculate an enrichment basal medium containing (g/L): (NH₄)₂SO₄, 1.5; MgSO₄.7H₂O, 0.25; KH₂PO₄, 0.25; yeast extract, 0.1. The pH was adjusted to 0.8 with H₂SO₄. Amounts of sterile chalcopyrite concentrate (Mount Is a Mines) and ore obtained from the sampling site were added to the medium as substrates to give final concentrations of 1% w/v. Culturing was carried out in shake flasks at 70° C. in a shaking incubator. Over time, cultures were examined using a phase contrast microscope for the presence of cells. When required, fresh medium of the same composition was used for subculturing.

Identification and Characterisation

Subsamples of each culture were pelleted and resuspended twice in 1× phosphate buffered saline (pH 7.2) as a washing step to remove dissolved metals and to neutralise pH. Aliquots from each of these cell suspensions were used directly as templates in a polymerase chain reaction (PCR) using the HotStarTaq™ Master Mix (Qiagen). An Archaea-specific primer set was used to amplify the 16S rDNA. PCR products were purified using an UltraClean™ PCR Clean-up Kit (MOBIO). Otherwise PCR and sequencing reactions were performed as previously described (Plumb et al., 2001). A near complete 16S rRNA sequence derived from the rDNA sequence is provided in SEQ ID NO:1. Analysis of sequence data was performed initially using BLAST (Basic Local Alignment Search Tool, Altschul et al., 1990) and then further phylogenetic analysis was performed using the ARB software package (www.mikro.biologie.tu-muenchen.de/).

Chemolithotrophic growth through the oxidation of Fe²⁺ and S⁰ was tested by measuring decreases in Fe²⁺ concentration using a calorimetric method (Wilson, 1960), and by monitoring the decrease in culture pH due to the oxidation of S⁰ to sulphate. The pH range for growth of the culture was tested over a pH range from 0.3 to 2.2. Basal medium was prepared at the appropriate pH and chalcopyrite concentrate (1% w/v) was again used as a growth substrate. Repeated subcultures at pH 0.3 were made to confirm growth at this low pH. The temperature range for growth of the culture was also tested. This was performed by incubating cultures growing on chalcopyrite concentrate at a range of temperatures from 50° C. to 85° C. Growth of the organisms was detected by microscopy.

The ability of the culture to leach chalcopyrite at pH 0.8 was tested using shake flask cultures in basal medium containing chalcopyrite concentrate at (1% w/v). Another laboratory isolate of Sulfolobus solfataricus (strain JP2) (Plumb et al., 2002) also capable of leaching chalcopyrite concentrate was used as a reference in a parallel experiment. Strain JP2 was cultured on the same medium but at pH 1.8. Total iron and copper concentrations in solution were monitored throughout using inductively-coupled plasma atomic emission spectrophotometry. Photomicrographs of selected culture samples were collected using a Canon D60 digital camera.

### EXAMPLE 1

### Isolation & Enrichment of JP7

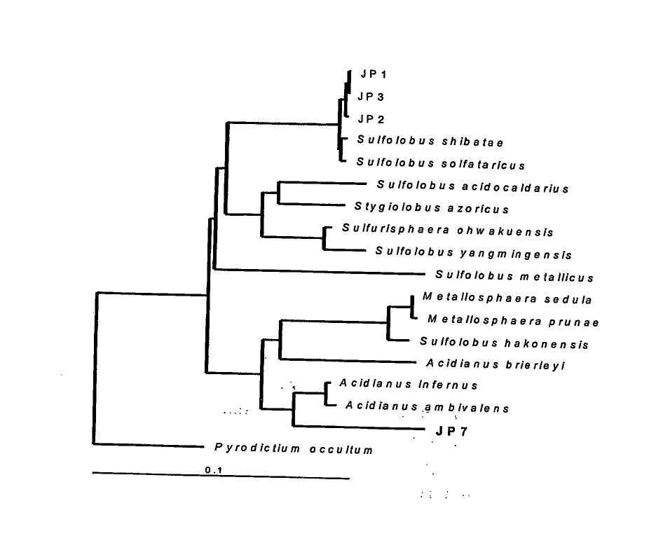

A culture was successfully enriched at pH 0.8 and 70° C. on the basal medium plus chalcopyrite concentrate and site ore material and was subsequently named JP7. The cellular morphology of JP7 was similar to that of members of the Sulfolobales group i.e. irregular shaped cocci of between 0.5 and 1 μm diameter. After repeated subculturing, an effort was made to identify the culture by 16S rDNA sequencing. The 16S rDNA sequence data obtained showed no evidence of mixed sequence template or any evidence of chimeric sequences that would indicate that the culture was mixed. According to 16S rDNA sequence date JP7 was approximately 94% similar to the previously described Acidianus ambivalens, a thermoacidophilic species of Archaea. FIG. 1 shows the phylogenetic position of JP7 relative to other members of the Sulfolobales based on 16S rDNA sequence analysis. This analysis shows that JP7 is either a novel species of the genus Acidianus or a representative of a novel genus. JP7 has been deposited at the Deutsche Sammlung Von Mikroorganismen Und Zellkulturen (DSMZ), Mascheroder Weg 1b, D-38124 Braunschweig, Germany under the provisions of the Budapest Treaty on 24 Feb. 2003 under the accession number DSM 15471.

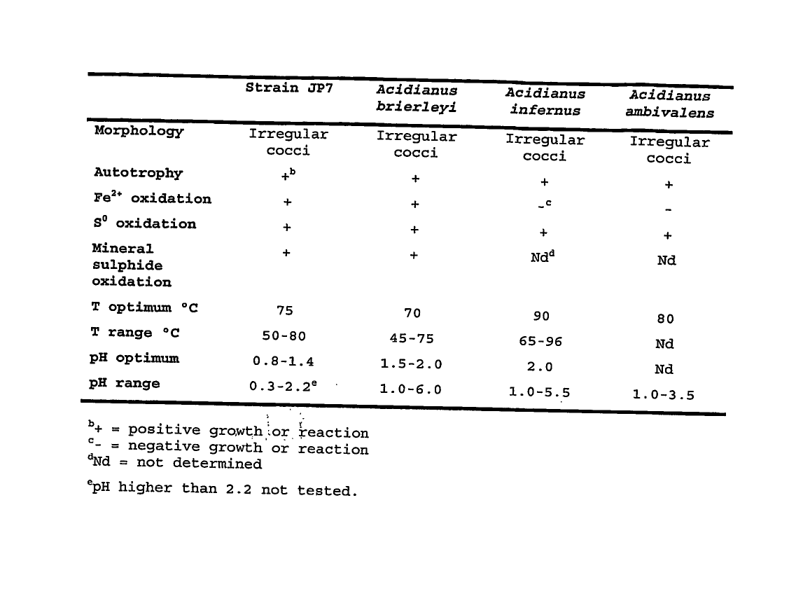

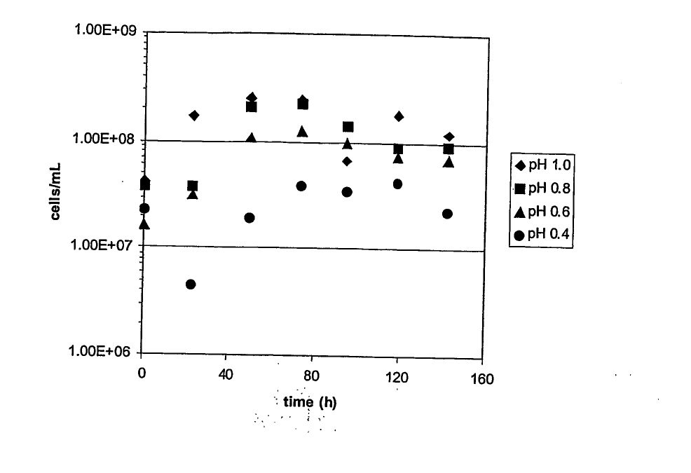

A comparison of the key characteristics of JP7 with other described Acidianus species is provided in FIG. 2. Growth curves for shake flask cultures of strain JP7 growing at 70° C. on 1% w/v chalcopyrite concentrate at a range of different pH are illustrated in FIG. 3. Cell counts were obtained using a Thoma counting chamber.

### EXAMPLE 2

### Bioleaching of Chalcopyrite Concentrate

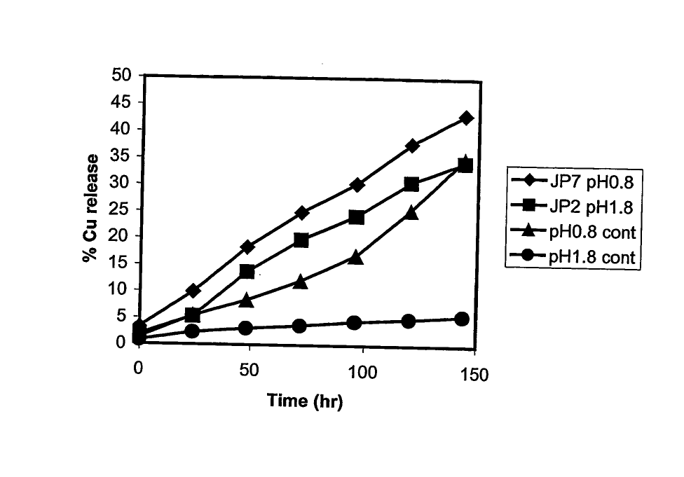

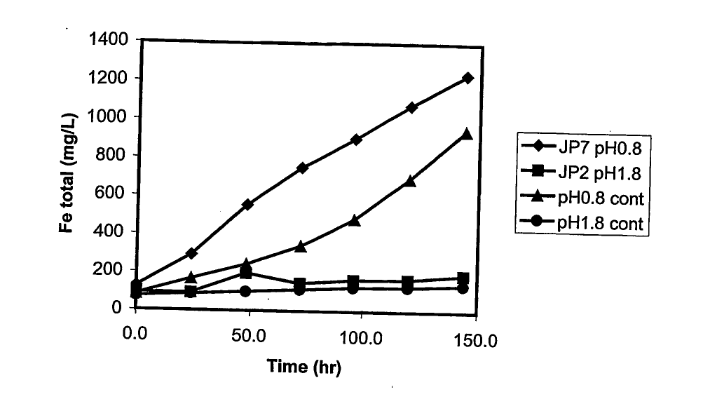

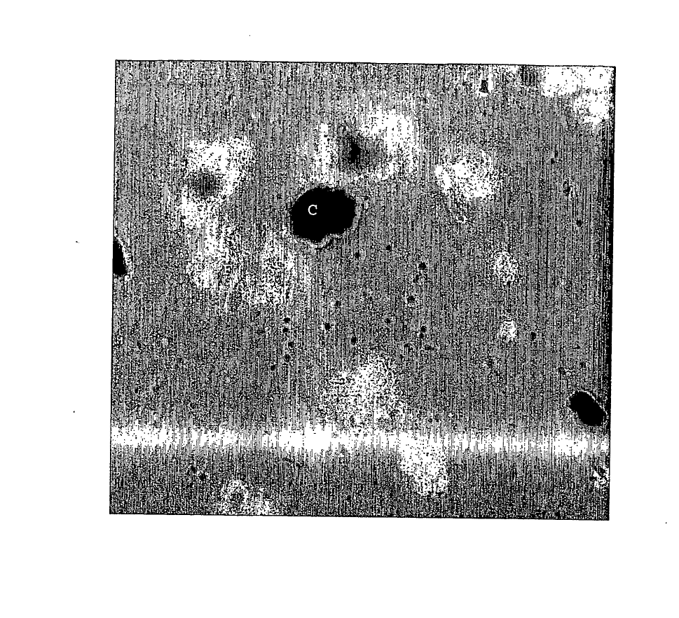

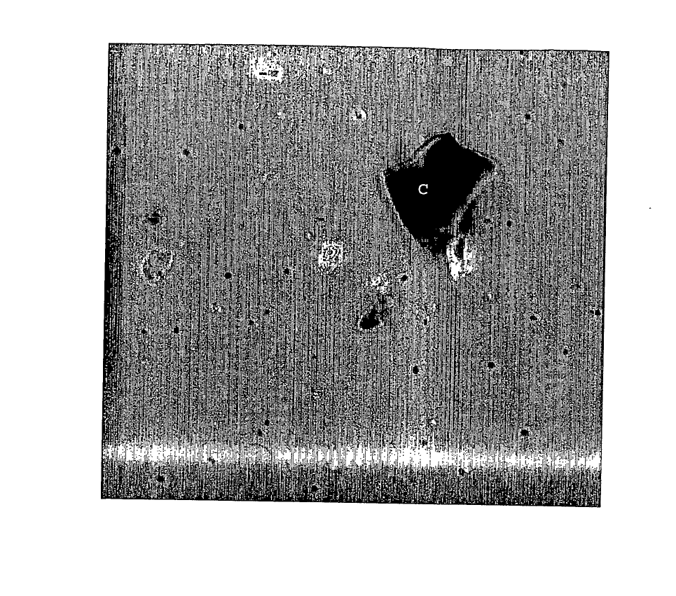

The ability of JP7 to leach chalcopyrite concentrate is shown in FIG. 4. A greater percentage of Cu release was obtained by JP7 at pH 0.8 compared with JP2 at pH 1.8, the optimal pH respectively for growth of each of these organisms on chalcopyrite. At the extremely low pH of 0.8, ferric iron precipitates such as jarosite did not form, resulting in a greater concentration of Fe³⁺ in solution. Given that Fe³⁺ is a strong leaching agent, a high percentage of Cu release was obtained. Also, the greater concentration of sulphuric acid at pH 0.8 would also likely increase the rate of chalcopyrite leaching. The data presented in FIG. 5 show the total iron in solution in each treatment. At pH 1.8, iron is only in solution at low levels. For the JP2 culture, this is because jarosite precipitates have formed which remove iron from solution. For the uninoculated pH 1.8 control, iron is only in solution at comparatively low concentrations partly due to the formation of ferric precipitates, but probably also because there is very little dissolution of chalcopyrite occurring in the absence of microorganisms. Microscopic examination of the JP2 and JP7 cultures at the different pHs helped demonstrate the differences in iron solubility. FIGS. 6 and 7 respectively show the microorganisms in the presence of the chalcopyrite concentrate particles, with (pH 1.8) or without (pH 0.8) ferric precipitates.

It will be apparent to the person skilled in the art that while the invention has been described in some detail for the purposes of clarity and understanding, various modifications and alterations to the embodiments and methods described herein may be made without departing from the scope of the inventive concept disclosed in the specification.

1. A method of recovering a metal from a mineral sulphide material, the method comprising the steps of:
(i) bioleaching the mineral sulphide material at a pH less than 1.0 and at a temperature of at least 50° C. with a microorganism capable of contributing to the bioleaching to produce a bioleachate solution containing dissolved metal; and
(ii) recovering the metal from the bioleachate solution.

2. The method according to claim 1, wherein step (i) comprises bioleaching the mineral sulphide material at a pH of 0.8 or less.

3. The method according to claim 1 or claim 2, wherein step (i) comprises bioleaching the mineral sulphide material at a temperature of at least 60° C.

4. The method according to any one of claims 1 to 3, wherein the mineral sulphide material contains ferrous iron and step (i) comprises bioleaching the mineral sulphide material by oxidising either or both of the ferrous iron and one or more sulphur compounds of the mineral sulphide material.

5. The method according to any one of claims 1 to 4, wherein the mineral sulphide material is a chalcopyrite-bearing ore or a pyritic ore which is capable of producing acid upon oxidation.

6. The method according to claim 5, wherein the mineral sulphide material is chalcopyrite.

7. The method according to any one of claims 1 to 6, wherein step (i) comprises bioleaching the mineral sulphide material with the microorganism Acidianus sp. JP7 (Accession number DSM 15471).

8. The use of Acidianus sp. JP7 (DSM Accession number 15471) for bioleaching a mineral sulphide.

9. An isolated culture of Acidianus sp. JP7 (DSM Accession number 15471).


SEQUENCE LISTING (1 sequence)

SEQ ID NO: 1 - RNA, 1473 nt, Acidianus sp.
  misc_feature (3)..(3): n is a, c, g, or u
  misc_feature (11)..(11): n is a, c, g, or u
  misc_feature (1249)..(1249): n is a, c, g, or u
ucngguugaunccugccggacccgacugcuauagggguagggcuaagccaugggagucguacgcucucgguaagagggcguggcagacggcugaguaacacguggcuaacuuacccucgggauccggauaacuccgggaaacuggagcuaauccggaauagacaaaggguucugggacgauccuuugucgaaaugcccuuaagcuguaucccgcuuaagggcgcccgaggauagggcugcggcccaucaggcuguuggcgagguaauggcucgccaaaccgauaacggguaggggccgugagagcgggagcccccaguugggcacugagacaagggcccagguccuacggggcgcaccaggcgcgaaauguccccaaugcgggaaaccgugagggcgcuaccccuagugcccucgaaagagggcuuuucccuacugcagacagguaggggaauaagcggggggcaaggcuggugucagccgccgcgguaauaccagccccgcgaguggucgggacgcuuacugggcuuaaagcgcccguagccggcccuauaagucacugcuuaaaggcccgggcucaacccgggaaagggcagugauacuauagggcuagggggcgggagaggccggaaguacucccagaguaggggcgaaauccacagauccugggaggacuaccaguggcgaaagcguccggccagaacgcgcccgacggugaggggcgaaagccgggguagcaaaagggauuagauaccccuguagucccggcuguaaaccaugcaggcuaggugucgcguaggcuuugggccugcgcggugccgcagggaaacugguaagccugccgccuggggaguacgccugcaagggcgaaacuuaaaggaauuggcgggggagcaccacaagggguggaaccugcggcucaauuggagucaacgccuggaaucuuaccgggagagaccacaggaugacggccaggcuaacgaccuugccagacucguggagaggaggugcauggccgucgccagcucguguugugaaauguccgguuaaguccggcaacgagcgagacccucaccauuaguugguaucccggucuccggaucgggaccacacuaaugggacugccuccguuaaggaggaggaaggagagggccacggcaggucagcaugccccgaaacucccgggccgcacgcggguuacaauggcagggacagcgggauuccuaccccgaaagggggcgguaaucccunaaacccugccucaguugggaucgagggcugaaacucgcccucgugaacgaggaaucccuaguaaccgcacgucaacaucgugcggugaauacgucccugcuccuugcacacaccgcccgucgcuccacccgagugaggaagaagugaggcuucuugcccuucggggugggaagucgagcuucuuccucgcgaggggggagaagucguaacaagguaaccguaaa